(19) United States
(12) Patent Application Publication
(10) Pub. No.: US 2015/0129426 A1
(43) Pub. Date: May 14, 2015

(54) ELECTROCHEMICAL SENSING NANOCOMPOSITE

(71) Applicant: Middle Tennessee State University, Murfreesboro, TN (US)

(72) Inventors: Charles C. Chusei, Murfreesboro, TN (US); Mulugeta Wayu, Murfreesboro, TN (US); Ryan T. Spidle, Murfreesboro, TN (US); Adam K. Wanekaya, Murfreesboro, TN (US)

(73) Assignee: Middle Tennessee State University, Murfreeboro, TN (US)

(21) Appl. No.: 14/405,599

(22) PCT Filed: Jun. 4, 2013
(86) PCT No.: PCT/US13/44128

§ 371 Date: Dec. 4, 2014

Related U.S. Application Data
(60) Provisional application No. 61/655,826, filed on Jun. 5, 2012.
(60) Provisional application No. 61/737,369, filed on Dec. 14, 2012.
(60) Provisional application No. 61/776,121, filed on Mar. 11, 2013.

(51) Int. Cl. G01N 27/30; C07F 3/06

(52) U.S. Cl. CPC G01N 27/30; C07F 3/06
USPC 204/435; 556/131

(57) ABSTRACT

A zinc oxide-carbon nanotube composite is provided, the nanotube composite being selective and sensitive for detection of hydrogen peroxide, which is important for screening for early cancer detection, monitoring cardiovascular disease, detecting onset of food spoilage, and enzymatic reactions that produce hydrogen peroxide as a byproduct. Also provided are methods using said zinc oxide-carbon nanotube composite.

### CROSS REFERENCE TO RELATED APPLICATIONS

This application is related to Provisional U.S. Application No. 61/776,121, filed 11 Mar. 2013, Provisional U.S. Application No. 61/655,826, filed 5 Jun. 5 2012, and Provisional U.S. Application No. 61/737,369, filed 14 Dec. 2012, the priority of each of which is hereby claimed, and the contents of which are incorporated herein by reference in their entirety.

### BACKGROUND

1. Field

The present disclosure relates to a zinc oxide-carbon nanotube composite that is both selective and sensitive for the detection of hydrogen peroxide, which is important for screening for early cancer detection, monitoring cardiovascular disease, detecting onset of food spoilage and enzymatic reactions that produce hydrogen peroxide as a byproduct. The composite is also an effective sensor for acetaminophen and glucose. The composite of the present invention, which does not include precious metals in the method of manufacture, is comparable to conventional composites that include precious metals in the method of manufacture.

2. Description of Related Art

Zinc oxide (ZnO), an n-type semiconductor material, is an ideal candidate for biosensing materials (C. Wu, X. Qiao, J. Chen, H. Wang, D. Tan and S. Li, Mater. Lett. 2006, 60, 1828-1832; H. P. Bai, X. X. Lu, G. M. Yang and Y. H. Yang, Chinese Chem. Lett. 2008, 19, 314-318) due to its high conductivity, exciton binding energy (60 meV), wide band gap (3.37 eV) and high breakdown strength (J. Kubota, K. Haga, Y. Kashiwaba, H. Watanabe, B. P. Zhang and Y. Segawa, Appl. Surf. Sci. 2003, 216, 431-435; M. Gusatti, J. A. Rosario, G. S. Barroso, C. E. M. Campos, H. G. Riella and N. C. Kunhen, Chem. Eng. Trans. 2009, 17, 1017-1021). Accurate and selective detection of H₂O₂ is important for the detection of a host of enzymatic reactions that produce hydrogen peroxide (H₂O₂) as a byproduct, such as the detection of the on-set of food spoilage (J. Ping, J. Wu, K. Fan and Y. Ying. Food Chem. 2011, 126, 2005-2009), screening of cholesterol in blood to manage cardiovascular disease (M. Ahmad, C. Pan, L. Gan, Z. Nawaz and J. Zhu, J. Phys. Chem. C 2010, 114, 243-250), and monitoring signaling events triggering reactive oxygen species generation leading to oxidative stress (M. Malinouski, Y. Zhou, V. V. Belousov, D. L. Hatfield and V. N. Gladyshev. PLoS One 2011, 6, 1-10).

The instability of enzymatic reactions is problematic for practical sample analysis (S. Li, Y. Zheng, G. W. Qin, Y. Ren, W. Pei and L. Zuo, Talanta 2011, 85, 1260-1264). Chemically modified electrodes have proved to be an effective and sensitive way to detect H₂O₂ both in vivo and in vitro (Y. Chang, J. Qiao, Q. L. Liu, L. Z. Shangguan, X. W. Ma, S. M. Shuang and C. A. Dong, Anal. Lett. 2008, 41, 3147-3160; Q. Rui, K. Komori, Y. Tian, H. Liu, Y. Luo and Y. Sakai, Anal. Chim. Acta 2010, 670, 57-62). For most electrochemical sensors, the detection of H₂O₂ was achieved at its oxidation potential (˜+0.6V vs Ag/AgCl), which is susceptible to interferences from extraneous electroactive compounds (A. A. Karyakin, E. E. Karyakina and L. Gorton, Talanta 1996, 43, 1597-1606), thereby reducing selectivity. For selective detection of H₂O₂, decreasing the oxidation potential or performing at its reduction potential is essential.

The solution to this technical problem is provided by the embodiments characterized in the claims.

### BRIEF SUMMARY

The present application relates to a method of controlling the morphology and size of ZnO nanostructures by varying the hydrothermal treatment temperature during hydrothermal synthesis prior to attaching the ZnO nanostructures to carboxylic acid functionalized multi-walled carbon nanotubes (COOH-MWNT) for sensing applications. High electrocatalytic activity for H₂O₂ reduction may be achieved using the ZnO nanostructures of the present invention.

An embodiment of the present disclosure is directed to a method of preparing a nanocomposite, comprising: preparing a zinc oxide nanostructure; and attaching the zinc oxide nanostructure to a carboxylic acid-functionalized multiwalled carbon nanotube. In one aspect, preparing the zinc oxide nanostructure comprises performing hydrothermal synthesis in NaOH at a temperature from about 30° C. to less than about 100° C. In one aspect, the temperature is from about 90° C. to less than about 100° C. In one aspect, the zinc oxide nanostructure has an average diameter of from about 20 nm to about 80 nm. In one aspect, the zinc oxide nanostructure has an average diameter of about 50 nm to about 60 nm. In one aspect, attaching the zinc oxide nanostructures to carboxylic acid-functionalized multiwalled carbon nanotubes comprises performing ultrasonication in absolute anhydrous ethyl alcohol. In one aspect, attaching the zinc oxide nanostructures are completely free of needle-like structures. In one aspect, the carboxylic acid-functionalized multiwalled carbon nanotube has a diameter of about 30 nm. An embodiment of the instant disclosure is directed to an electrode formed by the aforementioned methods.

An embodiment of the present disclosure is directed to an electrode comprising a zinc oxide nanostructure and a carboxylic acid functionalized multi-walled carbon nanotube. In one aspect, the zinc oxide nanostructure has an average diameter of from about 20 nm to about 80 nm. In one aspect, the zinc oxide nanostructure has an average diameter of about 50 nm to about 60 nm. In one aspect, the carboxylic acid-functionalized multiwalled carbon nanotube has a diameter of about 30 nm. In one aspect, the electrode has a peak current (Iₚ) of at least about 0.2 mA. In one aspect, the electrode has a peak current (Iₚ) of at least about 0.4 mA. In one aspect, the electrode has a peak current (Iₚ) of at least about 0.5 mA. In one aspect, the electrode has an electroactive surface area of at least about 0.9 cm². In one aspect, the electrode has an electroactive surface area of at least about 1.4 cm². In one aspect, the electrode has a reduction potential peak (E_{c}) of about −430 mV or greater versus Ag/AgCl (3.5 M KCl). In one aspect, the electrode has a reduction potential peak (E_{c}) of about −360 mV or greater versus Ag/AgCl (3.5 M KCl).

An embodiment of the present disclosure is directed to an electrode prepared by the method comprising: preparing a zinc oxide nanostructure via hydrothermal synthesis in NaOH at a temperature from about 90° C. to less than about 100° C.; and attaching the zinc oxide nanostructure to a carboxylic acid-functionalized multiwalled carbon nanotube.

An embodiment of the present disclosure is directed to use of any one of the aforementioned electrodes for detecting H₂O₂.

An embodiment of the present disclosure is directed to use of any one of the aforementioned electrodes for detecting acetaminophen.

An embodiment of the present disclosure is directed to use of any one of the aforementioned electrodes for detecting glucose.

An embodiment of the present disclosure is directed to use of any one of the aforementioned electrodes for detecting H₂O₂, acetaminophen, or glucose, wherein said detecting is performed at about pH 3.0 to about pH 11.0.

An embodiment of the present disclosure is directed to use of any one of the aforementioned electrodes for detecting H₂O₂, acetaminophen, or glucose, wherein said detecting is performed at about pH 6.0 to about pH 8.0.

An embodiment of the present disclosure is directed to use of any one of the aforementioned electrodes for detecting H₂O₂, acetaminophen, or glucose, wherein said detecting is performed at about pH 7.0 to about pH 8.0.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements.

FIG. 1 shows X-ray excited Auger electron (XAES) spectroscopies of ZnO nanoparticles at 90° C.

FIG. 2 shows (A) Zn 2p and (B) O 1s orbitals of ZnO nanoparticles hydrothermally synthesized at 90° C.

FIG. 3 shows X-ray diffraction (XRD) patterns of ZnO hydrothermally synthesized from 30° to 100° C. The phase structure at the 60-100° C. range matches that of the zinc oxide phase zincite (JCPDS card #00-036-1451).

FIG. 4 shows transmission electron microscopy (TEM) images of ZnO nanostructures produced at hydrothermal treatment temperatures of 30-90° C. prior to incorporating into COOH-MWNT nanocomposites.

FIG. 5 shows the diameter size distribution of ZnO nanostructures hydrothermally prepared at (A) 30° C.; (B) 40° C.; (C) 50° C.; (D) 60° C.; (E) 70° C.; (F) 80° C.; and (G) 90° C.

FIG. 6. shows a UV-vis spectrum of ZnO treated at (a) 60° C., (b) 70° C., (c) 80° C. and (d) 90° C.

FIG. 7 shows relative percentages (obtained from a composite count of nanostructures) of needle-like to semi-spherical (particle-like) shaped ZnO nanostructures produced as a function of hydrothermal treatment temperature.

FIG. 8 shows (A) an energy dispersive spectrum (EDX); and (B) a scanning transmission electron micrograph (STEM) of ZnO in nanocomposite.

FIG. 9 shows STEM images of (A) 40° C. ZnO/COOH-MWNTs, (B) 60° C. ZnO/COOH-Ts; and (C, D) 90° C. ZnO/COOH-MWNTs. White structures denote ZnO as confirmed by EDX. Flexible strands denote COOH-MWNTs.

FIG. 10 shows (A) cyclic voltammograms of NAFION®/ZnO/MWNTs/GCE in N₂ saturated 70 mM PBS solution containing 10 mM H₂O, at pH=7.4, 25° C. and scan rate of 50 mV·s-1 using ZnO nanostructures prepared using hydrothermal temperatures at (a) 40° C., (b) 50° C., (c) 60° C. ZnO and (d) 90° C.; (B) current response of the nanocomposites versus reaction temperature.

FIG. 11 shows cyclic voltammograms of (a) bare GCE, (b) NAFION®/COOH-T/GCE and (c) NAFION®/ZnO/COOH-MWNT/GCE with 10 mM H₂O, in N, saturated buffer solutions at the pH indicated, and at a scan rate of 50 mV·s⁻¹.

FIG. 12 shows (A) cyclic voltammogram responses for H₂O, detection at a) 0.5, b) 1.0, c) 5.0, d) 7.5, e) 10.0, f) 12.5, g) 15.0, h) 17.5, and i) 20.0 mM concentrations. Inset shows a linear relationship between current (μA) and H₂O, concentration (mM); and (B) control cyclic voltammogram responses for various concentrations of uric acid, ranging from 0.1 to 20 mM.

FIG. 13 shows scanning electron microscopy (SEM) micrographs of ZnO nanoparticles treated at 70° C. and 90° C. (A) ZnO at 70° C. 100,000× magnification; (B) ZnO at 90° C. 100,000× magnification; (C) ZnO at 70° C. 25,000× magnification; and (D) ZnO at 90° C. 25,000× magnification.

FIG. 14 shows an energy dispersive spectrum (EDX) of ZnO nanoparticles at 90° C.

FIG. 15 shows cyclic voltamograms of acetominophen (0.1 to 20 mM) at pH 7.4. Peak-to-peak heights measured at 0.54 to 0.75 V.

FIG. 16 shows that the zinc oxide-carbon nanotube composite can be used to detect glucose. FIG. 16A shows cyclic voltamograms of glucose at 10 to 70 mM. FIG. 16B shows current (mA) as a function of glucose concentration (10 to 70 mM). FIG. 16C is a schematic diagram showing how the electrode system disclosed can be used to detect glucose.

### DETAILED DESCRIPTION

Before the subject disclosure is further described, it is to be understood that the disclosure is not limited to the particular embodiments of the disclosure described below, as variations of the particular embodiments may be made and still fall within the scope of the appended claims. It is also to be understood that the terminology employed is for the purpose of describing particular embodiments, and is not intended to be limiting. Instead, the scope of the present disclosure will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this disclosure belongs.

According to the present disclosure, the technique of synthesizing high purity ZnO nanostructures is highly effective and facile (90% reaction yield) at low cost. In step (i), the morphology of ZnO nanostructures changes from needle-like to semi-spherical shape with increasing hydrothermal treatment temperature, with a sharp transitional change between the two populations at ˜55° C. These results show that semi-spherically shaped ZnO produce sensitive electrocatalysts at physiological conditions (pH=7.4). There is a strong dependence on ZnO morphology in the preparation of electrocatalytically active ZnO/COOH-MWNT for the detection of H₂O₂. The detection of H₂O₂ at lower over-potential may be enhanced with the increase in size of the ZnO precursor, indicative of high selectivity. The present invention provides high performance sensing materials that minimize or eliminate incorporation of precious metals.

The electrochemical sensing nanocomposites of the present invention are incorporated into glassy carbon electrode (GCE) surfaces via NAFION® sulfonated tetrafluoroethylene based fluoropolymer-copolymer film for voltammetric analyses of H₂O₂. The nanocomposites were synthesized in the following steps: (i) hydrothermal synthesis of ZnO nanostructures to control size and morphology, followed by (ii) attachment to COOH-MWNTs. The ZnO nanostructures were hydrothermally synthesized in the following manner. A 50.0 mL solution of 1.00 M NaOH was introduced in a 3-neck flask. The flask was then connected to a separating funnel containing 50.0 mL of 0.5 M Zn(NO₃)₂.6H₂O, a condenser and a controlled temperature probe. The NaOH was initially stirred and heated to a predetermined temperature after dripping Zn(NO₃)₂.6H₂O slowly into the NaOH over a period of 1 hour. The white precipitate that was formed was stirred continuously for an additional two hours at pre-selected temperatures. White suspensions at 90° C. were formed after 2 hours. The mixtures were filtered, washed with deionized water and dried at 65° C. for 1 hour. All ZnO nanostructure synthesis experiments were performed under inert N, atmosphere. In the second step, the ZnO nanostructure were attached to COOH-MWNTs via ultrasonication in absolute anhydrous ethanol for 1 hour at pH=7.4. To fabricate the sensor, the ZnO/COOH-MWNT composite was cast onto a glassy carbon electrode and allowed to dry with three applications. After drying a 2 wt % NAFION® solution was applied on top of the cast nanocomposite.

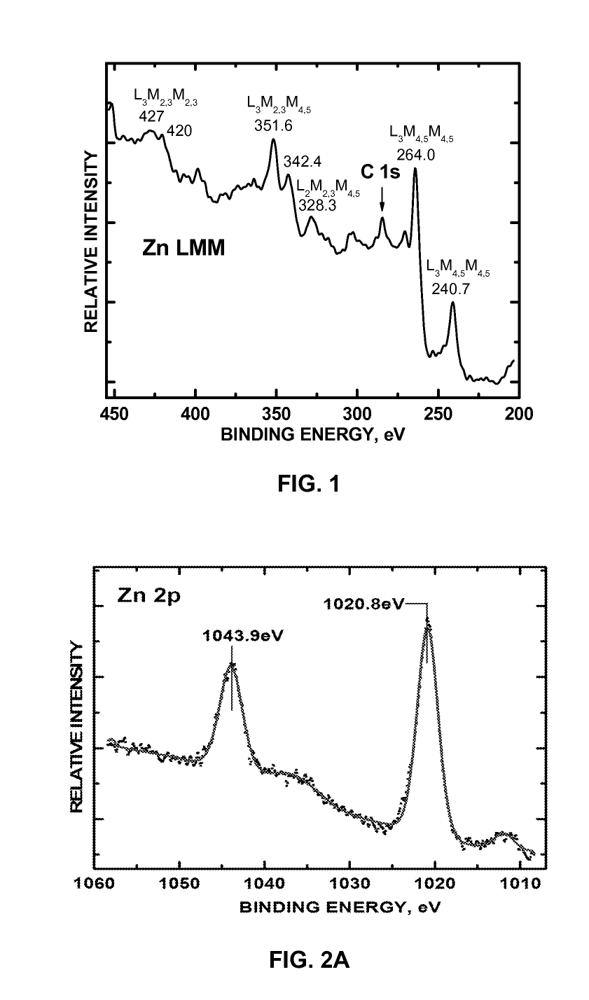

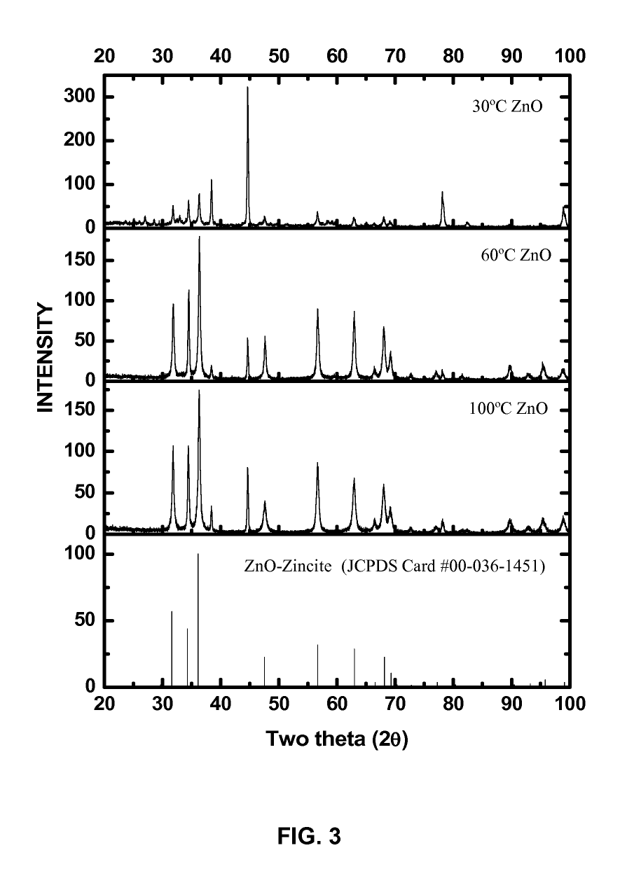

X-ray photoelectron (XPS) and X-ray excited Auger electron (XAES) spectroscopies (FIGS. 1 & 2) and lattice fringes observed in high resolution transmission electron microscopy (TEM) were used to verify that the ZnO nanostructures are pure. FIG. 3 shows the ZnO to be of a zincite phase. Pure ZnO nanostructures were synthesized at pre-determined hydrothermal treatment temperatures, from about 30° to about 100° C., from about 30° to about 90° C., from about 30° to about 80° C., from about 30° to about 70° C., from about 30° to about 50° C., from about 30° to about 40° C., from about 40° to about 100° C., from about 50° to about 100° C., from about 60° to about 100° C., from about 70° to about 100° C., from about 80° to about 100° C., from about 90° to about 100° C., from about 40° to about 90° C., from about 50° to about 80° C., from about 60° to about 70° C., from about 30° C., from about 40° C., from about 50° C., from about 60° C., from about 70° C., from about 80° C., from about 90° C., or from about 100° C., and preferably at about 90° C. Hydrothermal treatment temperature markedly affects ZnO nanostructure morphology with lower temperatures (˜30° C.) producing a high needle-like to semi-spherically shaped morphology while higher temperatures (˜90° C.) result in predominantly semi-spherically shaped nanostructures.

### Experimental

All chemical were purchased from Sigma-Aldrich, St Louis, Mo. Briefly, a 50.0 mL solution of 1.00 M NaOH was introduced into a 3-neck flask. The flask was then connected to a separating funnel containing 50.0 mL of 0.5 M Zn(NO₃)₂.6H₂O, a condenser and a controlled temperature probe. The NaOH was initially stirred and heated to a predetermined temperature after dripping Zn (NO₃)₂.6H₂O slowly into the NaOH over a period of 1 hour. The white precipitate that formed was stirred continuously for an additional two hours at pre-selected temperatures, from 30° C. to less than 100° C. The mixtures were filtered, washed with deionized water and dried at 65° C. for 1 hour (Wahab, R.; Ansari, S. G.; Seo, H.-K.; Kim, Y. S.; Suh, E.-K.; Shin, H.-S. Solid State Sci. 2009, 11, 439-443). All ZnO nanostructure synthesis experiments were performed under inert N₂ atmosphere. After synthesis of the ZnO nanostructures, the ZnO nanostructures were attached to COOH-MWNTs via ultrasonication described by Fang et al. (Fang, B.; Zhang, C.; Zhang, W.; Wang, G. Electrochimica Acta 2009, 55, 178-182). Bamboo structure COOH-MWNTs (95+% purity, 30 nm diameter) were purchased from Nanolab, Inc. (Waltham, Mass., USA) and used for voltammetric electrocatalytic activity analysis.

### A. Mechanism of ZnO Nanostructure Growth

As a first step zinc nitrate was converted into Zn(OH)₂ colloids under alkali solution conditions (Reaction 1), during which part of the Zn(OH)₂ colloids were dissolved into Zn²⁺ and OH⁻ (Reaction 2). As the concentrations of Zn²⁺ and OH⁻ reached the supersaturation, ZnO nuclei formed (Reaction 3) as shown in the following scheme:

Zn(NO₃)₂.6H₂O+2NaOH [symbol] Zn(OH)₂+2NaNO₃+6H₂O (1)

Zn(OH)₂+2H₂O [symbol] Zn²⁺+2OH⁻+2H₂O [symbol] Zn(OH)₄²⁻+2H⁺ (2)

Zn(OH)₄²⁻ [symbol] ZnO+H₂O+2OH⁻ (3)

where Δ is the hydrothermal reaction temperature between 30-100° C.

### B. Surface Characterization of the ZnO

UV-vis spectroscopy was conducted on a Perkin Elmer Lambda 650 UV-vis spectrometer. Scanning electron microscopy (SEM) was performed using a FEI Quanta 200 field emission microscope. Transmission electron microscopy (TEM) of the ZnO nanostructures was performed using a JEOL 1400 transmission electron microscope. ZnO nanostructure samples were prepared by applying a droplet on 200 mesh carbon-coated Cu TEM grids (SPI Supplies, West Chester, Pa., USA) for TEM imaging. Scanning transmission electron microscopy (STEM) was performed using a Tecnai G2F20 transmission electron microscope equipped with an energy dispersive X-ray spectrometer (EDX). ZnO/COOH-MWNT nanocomposite samples were prepared by applying droplets on lacey carbon film coated on 300 mesh nickel grids. The STEM data were analyzed using Image J version 1.38x software National Institutes of Health (NIH) (http://rsbweb.nih.gov/ij/download.html). X-ray photoelectron spectroscopy (XPS) was performed using a Perkin-Elmer ESCA PHI 560 instrument using a PHI 25-270AR double-pass cylindrical mirror analyzer operated at 250 Watts and 15 kV. Non-monochromatic X-rays were generated using Mg Kα anode operated at a photon energy of (hν=1253.6 eV). The binding energy (BE) for the C 1s level at 284.7 eV, denoting adventitious carbon (Barr, T. L. J. Vac. Sci. Technol. A 1995, 13, 1239-1246) was used for charge referencing. XPS spectra were deconvoluted with CasaXPS version 2.2.107 software (Devon, United Kingdom) using Shirley and Touggard background subtractions for the O 1s and Zn 2p orbitals, respectively, and 70%-to-30% Gaussian-Lorentzian line shapes. The ZnO solid sample was crushed into a powder and mounted onto the sample holder using double-sided tape (Scotch 3M) and out gassed in a turbo pumped antechamber prior to scans. The system pressure did not exceed 8.0×10⁻⁹ Torr pressure during XPS scans.

### C. Electrochemical Measurements

The electrochemical experiments were carried out using Model 273A potentiostat/galvanostat equipped with both GPIB (IEEE-488) and Serial (RS-232C) connectors and PowerSuite Electrochemistry software in conjunction with a three-electrode cell system consists of a single junction Ag/AgCl (3.5M KCl) as a reference electrode, a Pt wire as the auxiliary electrode and the NAFION®/ZnO/MWNTs modified GCE as working was utilized.

### D. Preparation of the Working Electrode

Prior to the modification, the GCE was polished to a mirror-like surface with alumina slurry followed by rinsing thoroughly with ultra-pure water. The electrode was successively sonicated in nitric acid (1:1) ultra-pure water for 5 minutes, and then allowed to dry at room temperature. The construction of the film consisting of ZnO/COOH-MWNTs on the surface of GCE was performed as follows: ZnO (2.00 mg) and MWNTs (2.00 mg) were suspended in 1.00 mL of absolute anhydrous ethyl alcohol (AAEA) to form a casting suspension. The casting suspension was then sonicated for 60 minutes in order to disperse the MWNTs and ZnO. Aliquots of 30 μL suspensions were coated onto the surface of a freshly polished GCE, and the electrode was dried in oven at 80° C. for 15 minutes to obtain the ZnO/COOH-MWNTs/GCE. Aliquots of 10 μL (2% wt) NAFION® solution in AAEA was casted on the as modified electrode and dried in oven at 80° C. for 15 min.

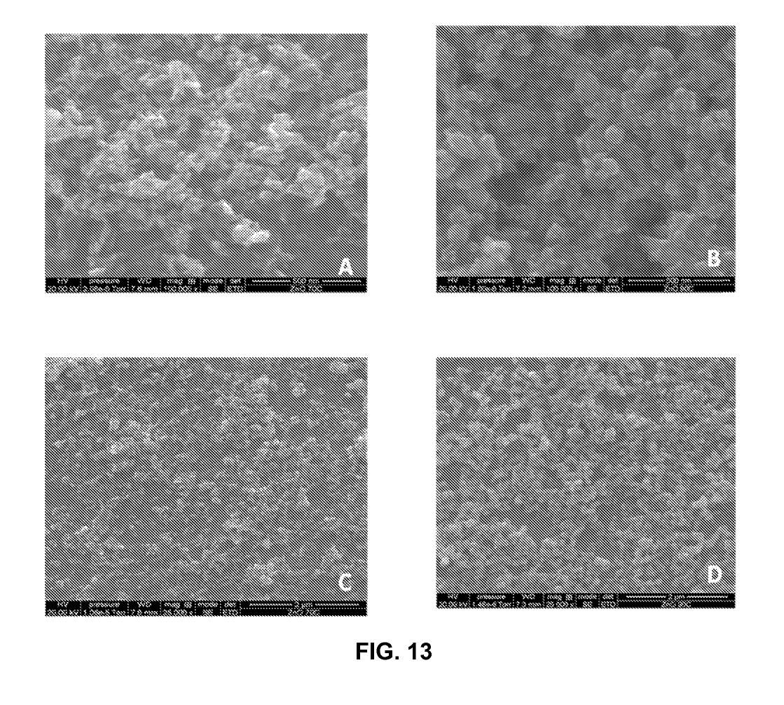

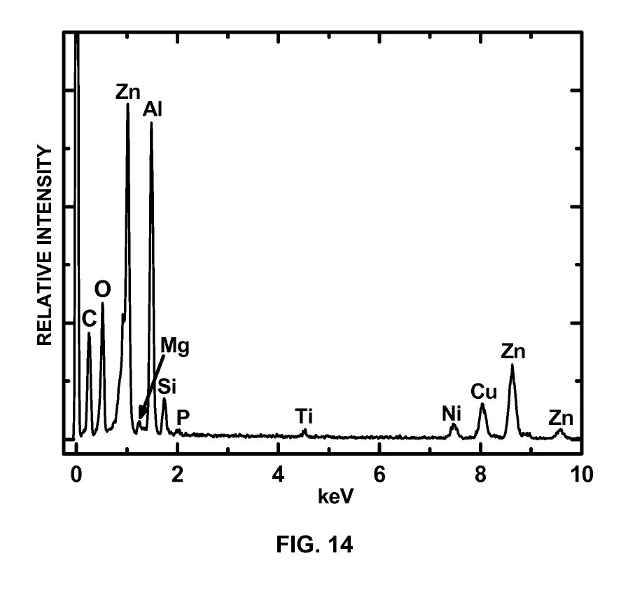

UV-vis data indicated that more uniform and narrow-size distributions spherical nanoparticles were obtained at higher temperatures (FIG. 6). SEM micrographs of the nanostructures synthesized between 70° C. and 90° C. (FIG. 13) show a size increase with increasing hydrothermal treatment temperature. The TEM micrograph and the size distribution also showed the same trend as the UV-vis absorption analysis. The TEM images of the ZnO nanostructures treated at 90° C. showed that the powder had, predominantly, a nanometer sized semi-spherical morphology. The EDX results also confirmed the synthesis process efficiency, showing a good quality elemental analysis (FIG. 14). TEM histograms of the nanostructures showed increasing diameters (composite average of both needle-like and semi-spherical nanostructures) with increasing hydrothermal treatment temperature (Table 1).

TABLE 1
ZnO diameter size as a function of
hydrothermal treatment temperature

| Temperature, ° C. | 40 | 50 | 60 | 90 |
|---|---|---|---|---|
| Diameter, nm | 31 ± 8 | 33 ± 5 | 34 ± 8 | 56 ± 18 |

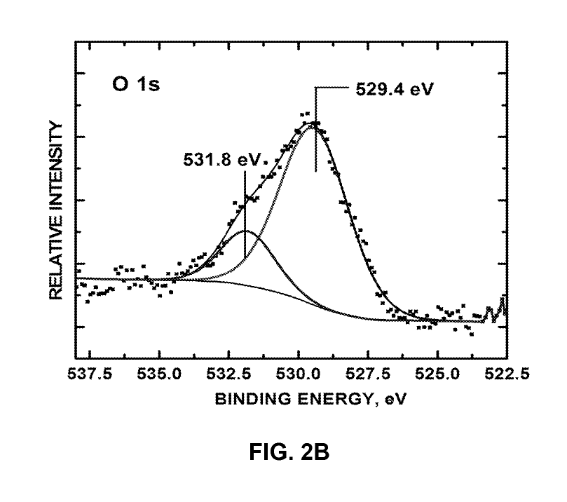

The Zn 2p_{3/2} orbital of the Zn(+2) typically overlaps with that of the metallic Zn(0) oxidation state, making it difficult to identify ZnO based on the 2p core level shift alone. However, the doublet separation of the 2p_{3/2} and 2p_{1/2} orbitals of ZnO at 1043.9 (2.90) and 1020.8 (3.21) eV (with fwhm in parentheses) is 21.9 eV (FIG. 2(A)). This result is consistent with the literature value for ZnO. The doublet separation, along with Auger Parameter (AP) analysis makes the ZnO assignment unambiguous. The O 1s oxidation state of ZnO shows two peaks (FIG. 2(B)): one at 529.4 (2.90) eV indicating ZnO oxygen, and another at 531.8 (2.28) eV showing a hydroxyl oxygen (McCafferty, E. and Wightman, J. P. Surf. Interface Anal. 1998, 26, 549-564; Haber, J.; Stoch, J.; Ungier, L. J. Electron Spectrosc. Relat. Phenom. 1976, 9, 459-467) arising from exposure to aqueous solution treatment used for the hydrothermal synthesis of ZnO. The slightly elevated Zn 2p_{3/2} binding energy for ZnO, ˜0.5 eV higher than that reported in the literature (Gaarenstroom, S. W.; Winograd, N. J. Chem. Phys. 1977, 67, 3500-3506), may be attributed to a result of extra-atomic relaxation of the O 1s core levels of the ZnO due to interaction with adsorbed hydroxyl groups.

Using the X-ray excited Auger electron spectrum (XAES) for the hydrothermally synthesized ZnO (at 90° C.) and taking into account the Zn L₃M_{4,5}M_{4,5} transition (FIG. 1), binding energy from the Zn 2p peaks (FIG. 2(A)) and the known photon energy of 1253.6 eV, an AP of 2010.4 eV was obtained, which matches the literature value for pure ZnO observed in the hydrothermal treatment at 90° C.

TABLE 2
Effect of hydrothermal treatment temperature of
ZnO nanostructures on the electrocatalytic activity
of ZnO/COOH-MWNTs nanocomposites at GCE

| Temperature, ° C. | 40 | 50 | 60 | 90 |
|---|---|---|---|---|
| Iₚ, mA | 0.207 | 0.352 | 0.395 | 0.564 |
| E_{c}, mV | −396 | −432 | −416 | −360 |

The Randles-Sevcik expression (at 25° C.) can be used to describe the electrocatalytic activity:

Iₚ=(2.99×10⁵)n(an)^{1/2}AC^{o}D^{1/2}v^{1/2} (4)

where Iₚ is the peak current, in amps, n is the number of electrons, A is the electrode area (cm²), D is the diffusion coefficient (cm²·s⁻¹), C⁰ is the concentration in mol·cm⁻³, and ν is the scan rate in V·s⁻¹.

In making comparisons of currents generated between each of the electrodes (Table 2), all variables were kept constant except for that of the electrode surface area, owing to the degree of exposed ZnO within the nanocomposite. Based on this fact and Randles-Sevcik expression (at 25° C.), the electroactive surface area between the electrodes were compared.

Iₚ₄₀=0.207×10⁻³A=(2.99×10⁵)n(αn)^{1/2}A₄₀C^{o}D^{1/2}v^{1/2} (5)

Iₚ₅₀=0.352×10⁻³A=(2.99×10⁵)n(αn)^{1/2}A₅₀C^{o}D^{1/2}v^{1/2} (6)

Iₚ₆₀=0.395×10⁻³A=(2.99×10⁵)n(αn)^{1/2}A₆₀C^{o}D^{1/2}v^{1/2} (7)

Iₚ₉₀=0.564×10⁻³A=(2.99×10⁵)n(αn)^{1/2}A₉₀C^{o}D^{1/2}v^{1/2} (8)

For instance, in comparing Equations (6) and (8),

$$\frac{{A}_{90}}{{A}_{50}} = \frac{1.42}{0.895} = 1.60$$

Hence, the greater electrocatalytic activity observed by the current peak-to-peak heights of a ZnO/COOH-MWNT electrode with a nanostructure precursor synthesized at 90° C. as compared to that of a ZnO/COOH-MWNT electrode with a nanostructure precursor synthesized at 50° C. can largely be attributable to the relatively greater electroactive surface area.

### EXAMPLES

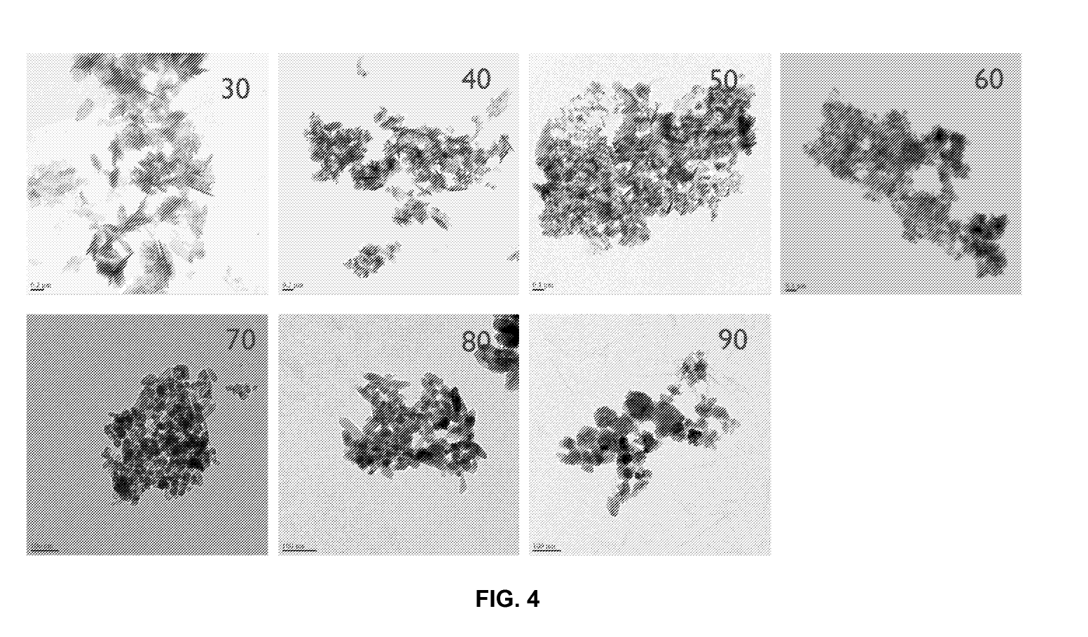

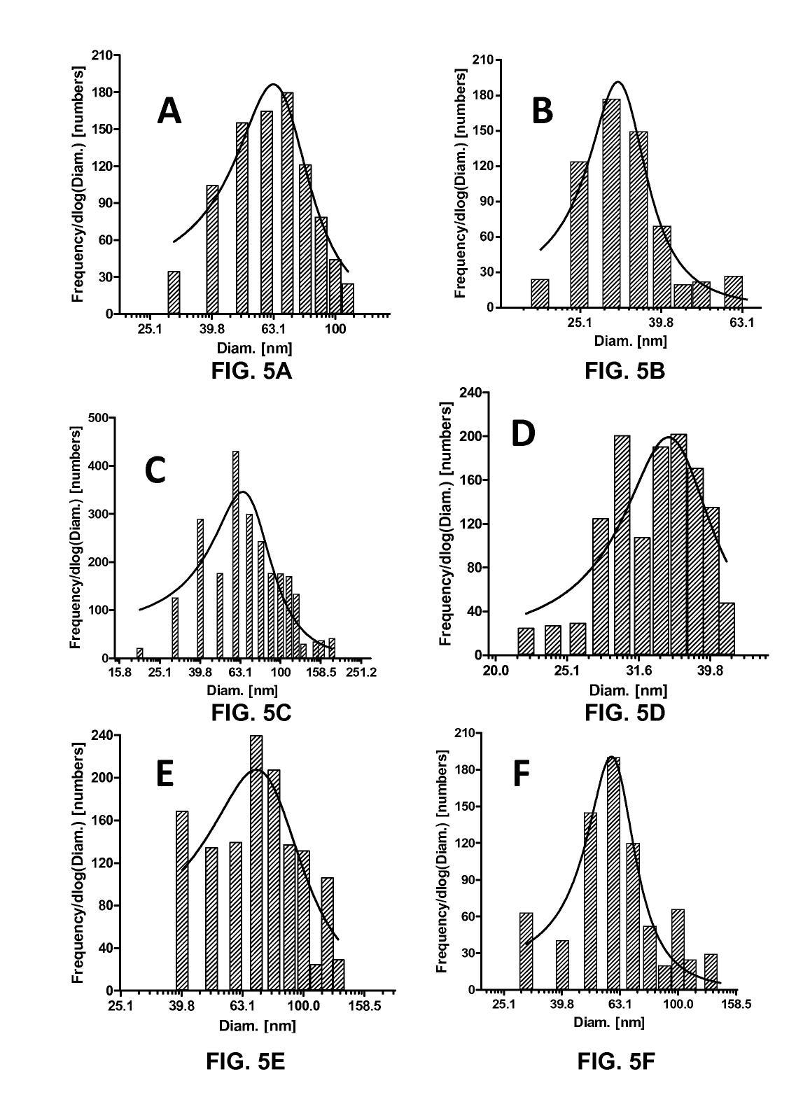

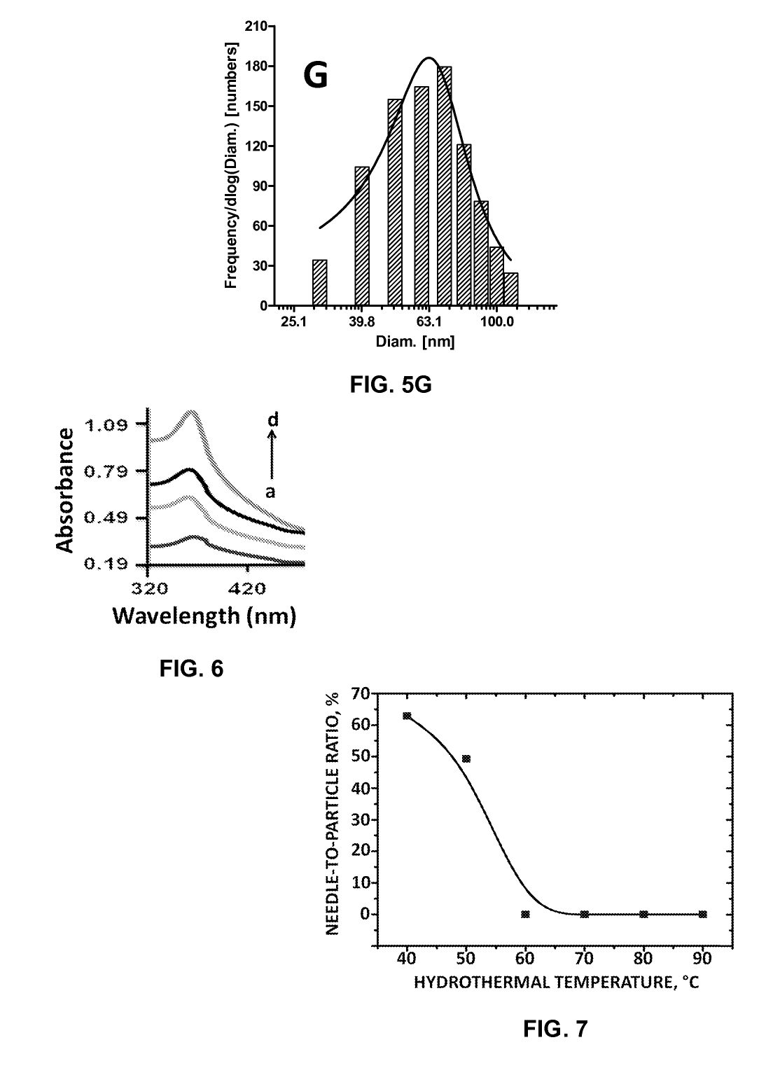

TEM images of ZnO nanostructures produced are shown in FIG. 4. The morphology and size of ZnO nanostructures synthesized at 30-90° C. were examined using TEM. The diameter size distribution of the ZnO nanostructures at 30-90° C. were analyzed (FIG. 5). The average diameter size (nm) of 31±8 for 40° C., 33±5 for 50° C., 34±8 for 60° C. and 56±18 for 90° C. were observed. The average diameter of the ZnO nanostructures may be from about 20 to about 80, from about 30 to about 70, from about 30 to about 60, from about 30 to about 55, from about 40 to about 55, from about 40 to about 60, from about 50 to about 60, about 55, and preferably about 56 nm. The increasing size also correlates with an increase in UV-vis absorbance with decreasing peak width at higher temperatures (FIG. 6), indicative of greater uniform size distribution of the ZnO. ZnO nanostructures treated at 40° C. and 50° C. yielded two types of nanostructures; needle-like and semi-spherically shaped nanostructures. The needle-like nanoparticles dominated at 40° C. and then a transition from needle-like to semi-spherically shaped nanoparticles was observed at 50° C. TEM images (FIG. 4) revealed agglomeration or cluster formation of nanostructures, which is attributed to the hydrophobicity of ZnO nanostructures in aqueous environment. It is known that Zn—O—Zn bonds form between ZnO nanoparticles under aqueous conditions, resulting in hard agglomerates (A. Merkoci, Microchim. Acta. 2006, 1 32, 157-174).

FIG. 7 shows the relative percent population of needle-like-to-semi-spherically shaped ZnO nanostructures as a function of hydrothermal treatment temperature. From the investigation of the relative populations of the two types of nanostructures, FIG. 7 shows the increase of the semi-spherical shaped ZnO nanostructures with increasing reaction temperature, maximizing at 60° C. Beyond this hydrothermal treatment temperature, the needle-like nanoparticles disappeared. This temperature denotes the transition state temperature of the conversion of needle-like shaped to semi-spherical shaped nanoparticles. A sharp transition occurred at ˜55° C. (FIG. 7).

Each of the ZnO nanostructures were then attached to COOH-MWNTs ˜30 nm in diameter via ultrasonication in absolute anhydrous ethyl alcohol to produce the electrochemical sensing nanocomposites for H₂O₂ detection with the carboxylate groups serving as stable tethering points of the ZnO nanostructures to the MWNT support (R. V. Hull, L. Li, Y. Xing and C. C. Chusuei, Chem. Mater. 2006, 18, 1780-1788).

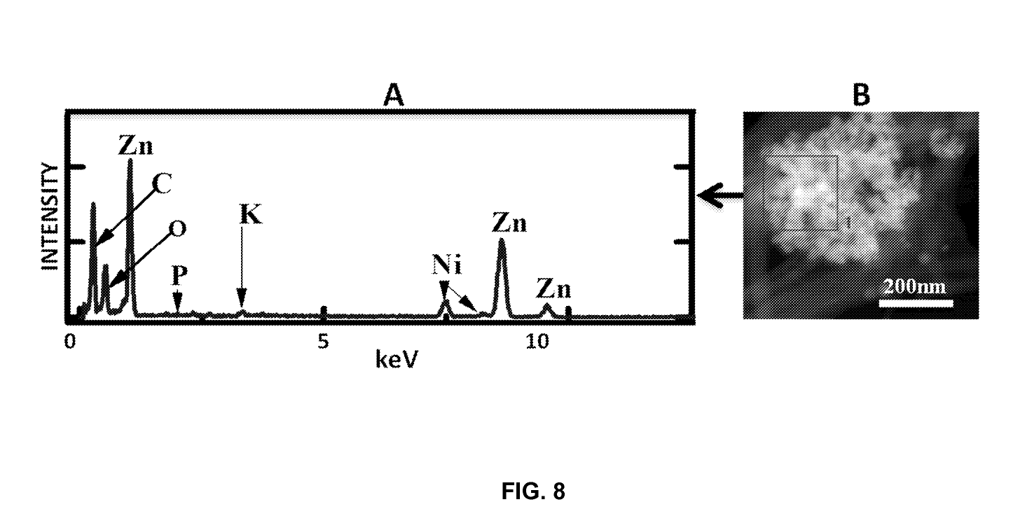

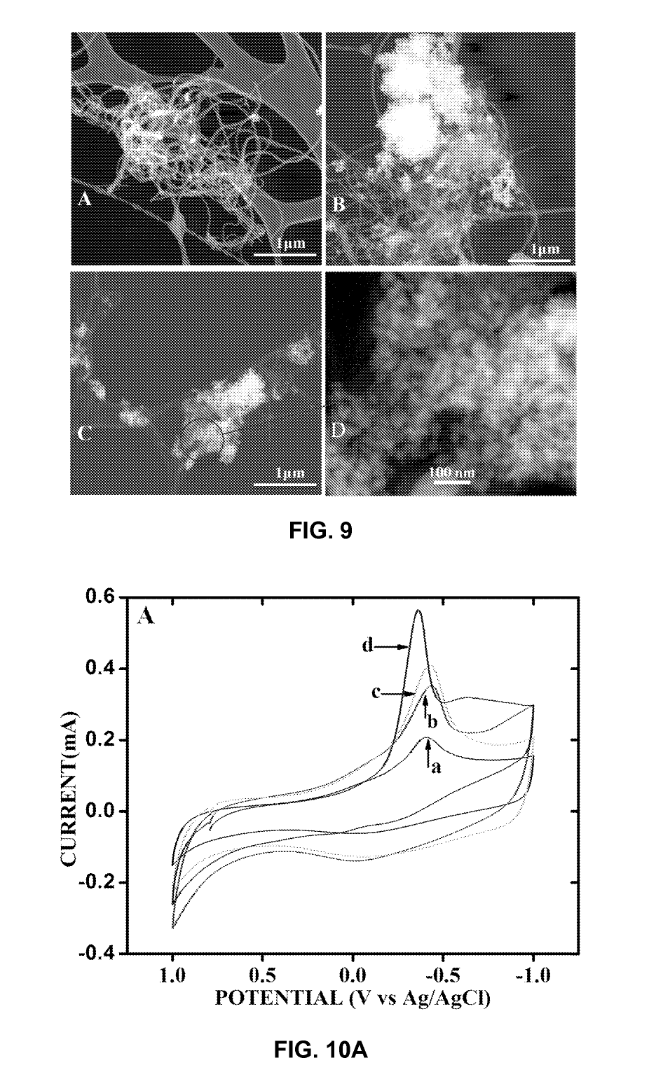

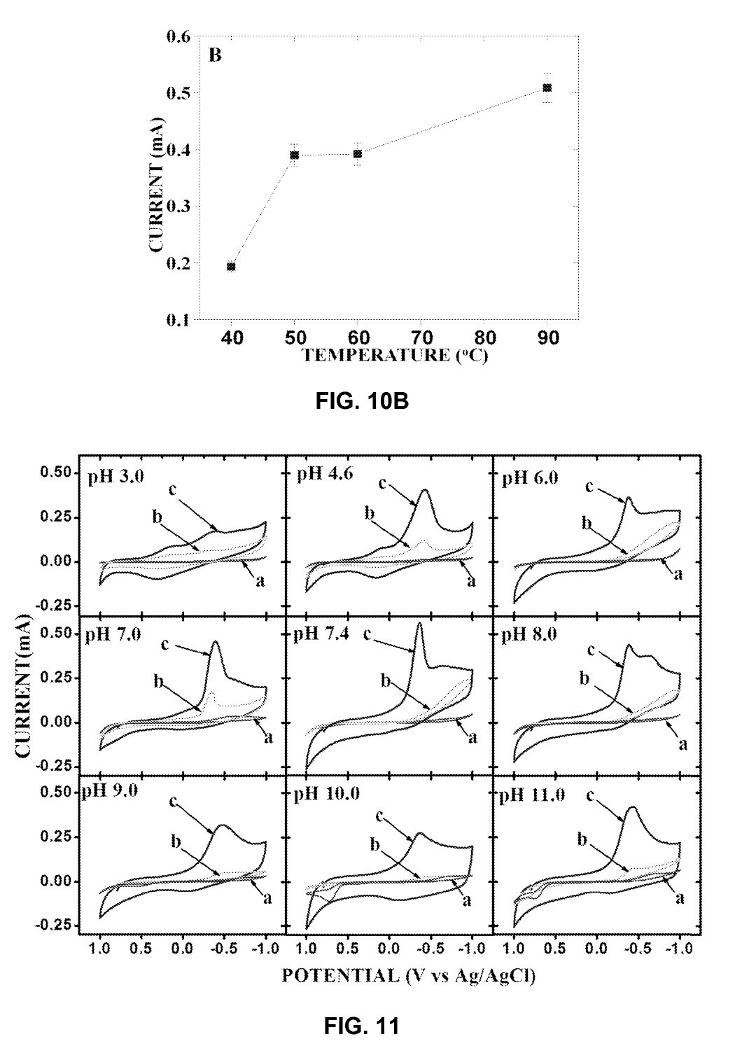

As shown in FIG. 8, scanning transmission electron micrographs (STEM) and EDX were used to verify the presence of ZnO tethered to the MWNT surface after the ultrasonication (step (ii) of nanocomposite synthesis). EDX results revealed the presence of Zn, O, and C on the surface of the nanotubes, which confirm the presence of attached ZnO. Ni emanated from the sample holder. P and K peaks are from trace impurities from the hydrothermal synthesis step. STEM images of ZnO/COOH-MWNTs composite at various hydrothermal treatment temperatures of ZnO nanostructures are shown in FIG. 9. The observed, marked increase in electrocatalytic activity in nanocomposites produced by hydrothermal treatment at 40° C. in step (i) compared to nanocomposites produced by hydrothermal treatment at 90° C. in step (i) (vide infra, FIG. 10), may be attributed to superior bonding of the ZnO to the MWNT substrate. The quality of the ZnO attachment to the MWNTs may vary. The resulting ZnO/COOH-MWNT nanocomposite generated from ZnO nanostructures hydrothermally synthesized at 40° C. showed ZnO sparsely populating the MWNT surface (FIG. 9A); most of the catalyst surfaces were Ts. When ZnO nanostructures hydrothermally synthesized at 60° C. was used, more of the T surface was covered, but approximately half of the MWNTs surface remained exposed (FIG. 9B). When ZnO nanostructures hydrothermally synthesized at 90° C. was used, the MWNT surface was completely covered, showing no exposure of the underlying nanotubes (FIGS. 9C and 9D). As shown in FIG. 9C, the MWNT surface was fully covered by ZnO nanoparticles. There is a strong correlation between ZnO nanostructure morphology in step (i), with completeness of surface coverage after step (ii) of the nanocomposite synthesis procedure. Needle-like shaped ZnO nanostructures result in poor attachment to COOH-MWNTs via ultrasonication (FIG. 9A).

FIG. 10 shows the effect of hydrothermal treatment temperature of ZnO nanostructures on the electrocatalytic activity of ZnO/COOH-MWNT nanocomposites (which were incorporated onto GCE working electrodes using NAFION® film) towards the reduction of H₂O₂. The increased peak-to-peak heights in the cyclic voltammograms correspond to increasing electrocatalytic activity. A 2.4-fold increase was observed in the nanocomposites generated from ZnO nanostructures hydrothermally synthesized at 90° C. compared to ZnO nanostructures hydrothermally synthesized at 40° C. in comparing the CV peak-to-peak heights. In irreversible cyclic voltammetry, the peak current is given by Randles-Sevcik expression (at 25° C.) as Iₚ=(2.99×10⁵)n(αn)^{1/2}ACD^{1/2}v^{1/2} where Iₚ is the peak current, in amps, n is the number of electrons, A is the electrode area (cm²), D is the diffusion coefficient (cm²·s⁻¹), C⁰ is the concentration in mol·cm⁻³, and v is the scan rate in V·s⁻¹. A ˜60% increase in the electroactive surface area of the electrode between 50° C. and 90° C. was determined using the Randles-Sevcik expression and the voltammogram data (FIG. 10 and Table 2). The enhanced electrocatalytic activity for H₂O₂ reduction may be attributed to the greater surface area present in ZnO nanostructures hydrothermally synthesized at 90° C.

The observed reduction potential (E_{c}) peaks for the ZnO/COOH T nanocomposites prepared using hydrothermal treatment temperatures of 40° C., 50° C., 60° C. and 90° C. were −396 mV, −432 mV, −416 mV, and −360 mV, respectively, as shown in Table 2. Also, the overpotential of the reduction of H₂O₂ decreased as the hydrothermal treatment temperature increased from 50° C. to 90° C., accompanying higher current response and indicative of high selectivity. Artifacts due to dissolved O₂, uric acid, ascorbic acid, etc. in samples may not interfere with H₂O₂ detection. The highest electrocatalytic activity in this series of nanocomposites was observed using ZnO nanocomposite precursors hydrothermally synthesized at 90° C. The sharp cathodic current peak was observed at −360 mV vs Ag/AgCl (3.5 M KCl), which is lower than previous literature reports. Further, the materials used the electrocatalyst of the present invention do not include precious metals, e.g., Au, Ag, Pt, common in conventional H₂O₂ sensors (M. Ahmad, C. Pan, L. Gan, Z. Nawaz and J. Zhu, J. Phys. Chem. C 2010, 114, 243-250; M. R. Miah and T. Ohsaka, Anal. Chem. 2006, 78, 1200-1205; M. R. Guascito, E. Filippo, C. Malitesta, D. Manno, A. Serra and A. Turco, Biosens. Bioelectron. 2008, 24, 1057-1063). Miah and Ohsaka reported −895 mV vs Ag/AgCl (NaCl, sat.) potential for the reduction of H₂O₂ on iodide-modified Au electrode in alkaline media. Guascito et al. reported −553 mV vs SCE for the reduction of H₂O₂ using Ag nanoparticles immobilized in a polyvinyl alcohol (PVA) film on a Pt electrode.

The effect of buffer pH on the detection of H₂O₂ is shown in FIG. 11. The cathodic current response of the composite increased from pH=3.0 to 7.4 and then decreased from pH=7.4 to 10.0 with a slight increase at 11.0. The maximum cathodic peak current of H₂O₂ is observed at pH =7.4 in 70.0 mM phosphate buffer saline (PBS) solutions. Noteworthy is that maximum current response coincides with physiological pH, rendering this nanocomposite practical for the electrochemical detection of H₂O₂, a by-product of many reactions catalyzed by oxidases.

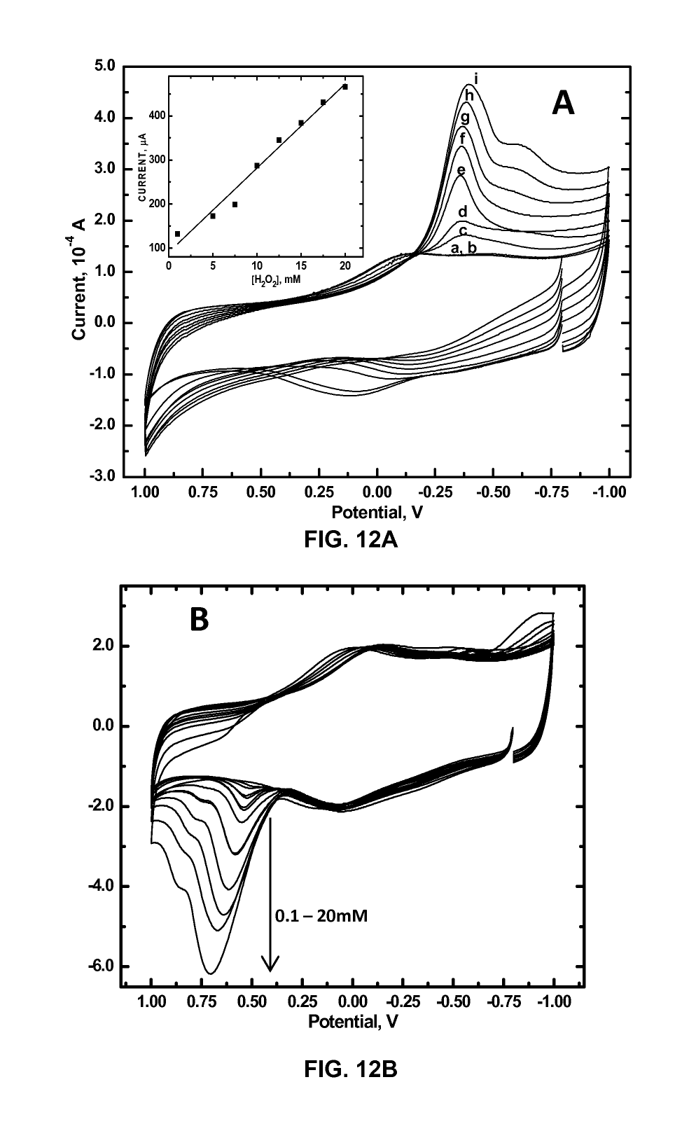

FIG. 12 shows a series of cyclic voltammograms generated using synthesized ZnO/COOH-MWNT composites of the present invention with known concentrations of hydrogen peroxide ranging from 0.5 mM to 20 mM. The current response is linear with H₂O₂ concentration in the 1-10 mM range, showing good stability (R²=0.9789). This reduction potential is far removed from interfering analytes. Uric acid (FIG. 12(B)) is a noteworthy interfering analyte, produced from metabolism and prevalent in urine samples was measured. Both samples were measured in phosphate buffer solution (pH 7.4). Oxidation potentials of uric acid (350-750 mV) are well separated from that of the H₂O₂ reduction potential (−360 mV) and are unlikely to interfere with H₂O₂ measurement.

The detection and quantification of hydrogen peroxide in biological samples is important for monitoring enzymatic reactions that produce this byproduct, notably for monitoring of cardiovascular disease and detection of the onset of food spoilage.

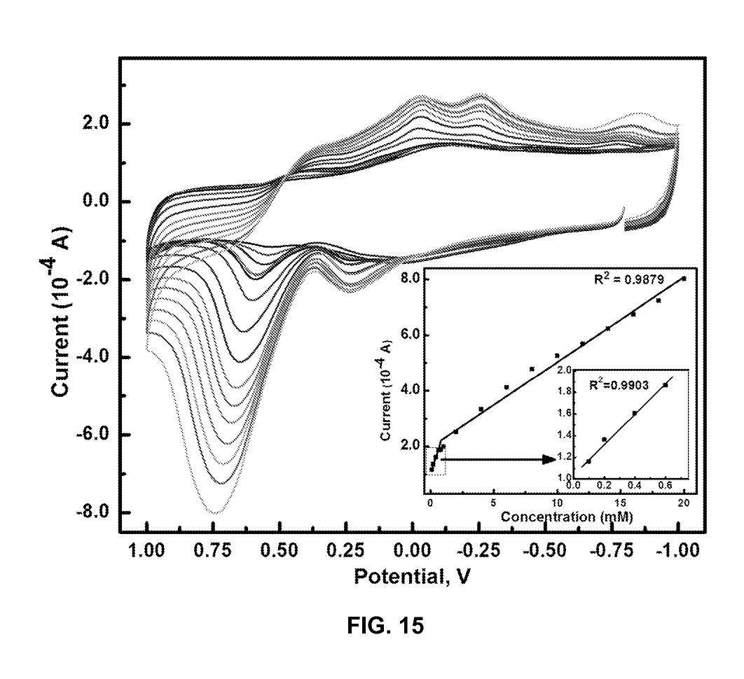

The zinc oxide-carbon nanotube composite of the present disclosure may also be used to detect acetaminophen. FIG. 15 shows quantitation between 0.1 mM to 20 mM of acetaminophen in aqueous solution media buffered to physiological conditions (see, e.g., inset). There is an interesting breakpoint at the 1.0 mM concentration, resulting in two linear regions (see arrow pointing to second inset).

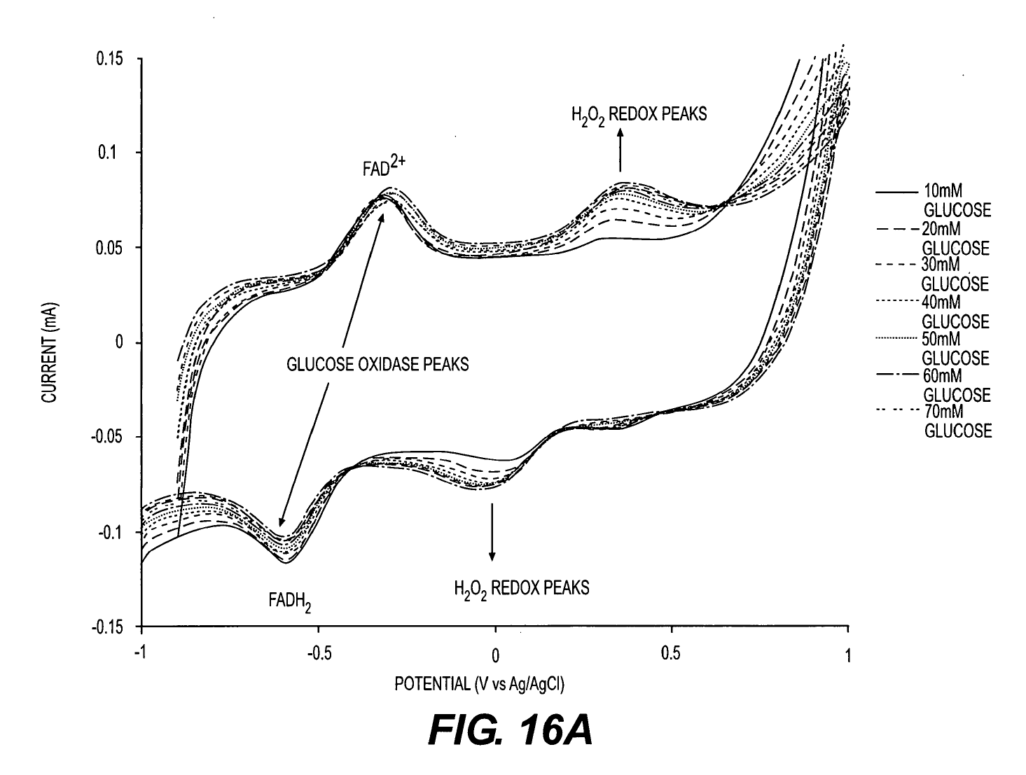

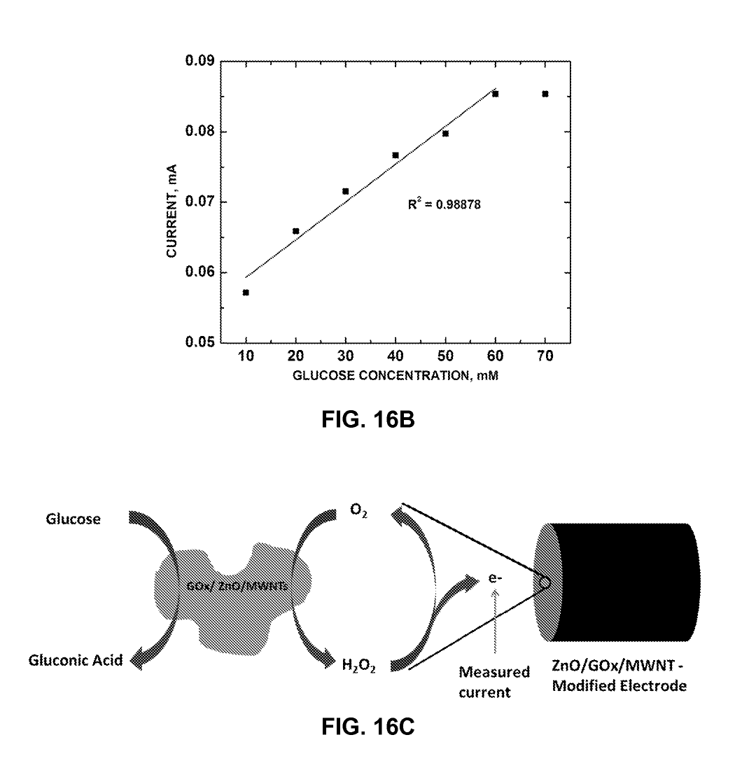

The zinc oxide-carbon nanotube composite of the present disclosure may also be used to detect glucose as a result of specific enzymatic reactions that produce hydrogen peroxide as a byproduct (see FIGS. 16A-16C). The enzyme used in this case is glucose oxidase (GOx), as shown schematically by the following equation:

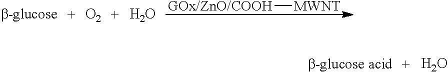

The characteristic redox peaks of glucose oxidase peaks at −0.3 V and 0.5 V are due to the oxidation and reduction of flavine adenine dinucleotide (FAD) cofactor in glucose (FIG. 16A). The magnitude of these peaks remains more or less constant with increasing glucose concentration. More importantly, the redox peaks of hydrogen peroxide at 0.0 V and 0.4 V are sensitive to the increase in glucose concentrations. A plateau is observed at a 60 mM concentration. This demonstrates how the electrode system can be used for sensing analytes as shown above for glucose.

One noteworthy aspect of the material as compared to conventional nanocomposites is that it does not employ precious metals in its fabrication, e.g., gold, silver, platinum, palladium, in its structure. The sensing materials formed may have overpotentials lower than other sensing materials in the literature indicative of selectivity. Rather, the electrocatalytic properties are achieved via control of ZnO morphology prior to attachment to COOH-MWNTs. Other aspects of the material fabrication include, selection of solvent for ultrasonication process, precise hydrothermal temperature to control ZnO morphology prior to attachment to COOH-MWNTs, precise pH conditions for attachment and precise ultrasonication time to form the nanocomposites. A particular concentration of NAFION® also may be required for optimum sensing performance. Too little and the electrocatalyst may not sufficiently adhere to the electrode surface. Too much and mass transfer may limit detection of the analyte reduction reaction. Variations in any of these aforementioned conditions result in marked reduction of selectivity and sensitivity for detecting and quantifying hydrogen peroxide in the biological sample. The synthetic process is facile, low-cost, involves a minimal amount of chemicals and amenable for industrial scale-up.

All references cited in this specification are herein incorporated by reference as though each reference was specifically and individually indicated to be incorporated by reference. The citation of any reference is for its disclosure prior to the filing date and should not be construed as an admission that the present disclosure is not entitled to antedate such reference by virtue of prior invention.

It will be understood that each of the elements described above, or two or more together may also find a useful application in other types of methods differing from the type described above. Without further analysis, the foregoing will so fully reveal the gist of the present disclosure that others can, by applying current knowledge, readily adapt it for various applications without omitting features that, from the standpoint of prior art, fairly constitute essential characteristics of the generic or specific aspects of this disclosure set forth in the appended claims. The foregoing embodiments are presented by way of example only; the scope of the present disclosure is to be limited only by the following claims.

1. A method of preparing a nanocomposite, comprising:
preparing a zinc oxide nanostructure; and
attaching the zinc oxide nanostructure to a carboxylic acid-functionalized multiwalled carbon nanotube.

2. The method of claim 1, wherein preparing the zinc oxide nanostructure comprises performing hydrothermal synthesis in NaOH at a temperature from about 30° C. to less than about 100° C.

3. The method of claim 2, wherein the temperature is from about 90° C. to less than about 100° C.

4. The method of claim 1, wherein the zinc oxide nanostructure has an average diameter of from about 20 nm to about 80 nm.

5. The method of claim 1, wherein the zinc oxide nanostructure has an average diameter of about 50 nm to about 60 nm.

6. The method of claim 1, wherein attaching the zinc oxide nanostructures to carboxylic acid-functionalized multiwalled carbon nanotubes comprises performing ultrasonication in absolute anhydrous ethyl alcohol.

7. The method of claim 1, wherein attaching the zinc oxide nanostructures are completely free of needle-like structures.

8. The method of claim 1, wherein the carboxylic acid-functionalized multiwalled carbon nanotube has a diameter of about 30 nm.

9. An electrode formed by claim 1.

10. An electrode comprising:
a. a zinc oxide nanostructure and
b. a carboxylic acid functionalized multi-walled carbon nanotube.

11. The electrode of claim 10, wherein the zinc oxide nanostructure has an average diameter of from about 20 nm to about 80 nm.

12. The electrode of claim 10, wherein the zinc oxide nanostructure has an average diameter of about 50 nm to about 60 nm.

13. The electrode of claim 10, wherein the carboxylic acid-functionalized multiwalled carbon nanotube has a diameter of about 30 nm.

14. The electrode of claim 10, having a peak current (Iₚ) of at least about 0.2 mA.

15. The electrode of claim 10, having a peak current (Iₚ) of at least about 0.4 mA.

16. The electrode of claim 10, having a peak current (Iₚ) of at least about 0.5 mA.

17. The electrode of claim 10, having electroactive surface area of at least about 0.9 cm².

18. The electrode of claim 10, having electroactive surface area of at least about 1.4 cm².

19. The electrode of claim 10, having a reduction potential peak (Eᵤ) of about −430 mV or greater versus Ag/AgCl (3.5 M KCl).

20. The electrode of claim 10, having a reduction potential peak (E_{c}) of about −360 mV or greater versus Ag/AgCl (3.5 M KCl).

21. An electrode prepared by the method comprising:
a. preparing a zinc oxide nanostructure via hydrothermal synthesis in NaOH at a temperature from about 90° C. to less than about 100° C.; and
b. attaching the zinc oxide nanostructure to a carboxylic acid-functionalized multiwalled carbon nanotube.

22. Use of the electrode of claim 10 for detecting H₂O₂.

23. Use of the electrode of claim 10 for detecting acetaminophen.

24. Use of the electrode of claim 10 for detecting glucose.

25. Use of the electrode of claim 10 for detecting H₂O₂, acetaminophen, or glucose, wherein said detecting is performed at about pH 3.0 to about pH 11.0.

26. Use of the electrode of claim 10 for detecting H₂O₂, acetaminophen, or glucose, wherein said detecting is performed at about pH 6.0 to about pH 8.0.

27. Use of the electrode of claim 10 for detecting H₂O₂, acetaminophen, or glucose, wherein said detecting is performed at about pH 7.0 to about pH 8.0.
